(19) United States
(12) Patent Application Publication
(10) Pub. No.: US 2017/0082893 A1
(43) Pub. Date: Mar. 23, 2017

(54) ELECTRO-OPTICAL DEVICE, ELECTRO-OPTICAL DEVICE MANUFACTURING METHOD, AND ELECTRONIC APPARATUS

(71) Applicant: Seiko Epson Corporation, Tokyo (JP)

(72) Inventor: Satoshi Ito, Eniwa-shi (JP)

(21) Appl. No.: 15/195,993

(22) Filed: Jun. 28, 2016

(30) Foreign Application Priority Data
Sep. 17, 2015 (JP) 2015-183743

(51) Int. Cl. G02F 1/1335; G02F 1/1343; G02B 3/00

(52) U.S. Cl. CPC G02F 1/133526; G02B 3/0056; G02F 1/1343

(57) ABSTRACT

An element substrate of an electro-optical device includes a light-transmitting substrate on one surface of which a plurality of lens surfaces including a concave surface are formed, and a light-transmitting lens layer that covers the plurality of lens surfaces. On one surface of the substrate, a recess region, which includes a concave-shaped lens forming region in which the plurality of lens surfaces are arranged, is formed. The plurality of lens surfaces are provided at the bottom of the recess region. The lens layer is provided such that the inner side of the recess region is filled. The surface of the lens layer on a side opposite to the substrate forms, on one surface of the substrate, a plane surface which is contiguous to an outside region positioned on an outer side of the recess region. The lens layer is not formed in the outside region.

### BACKGROUND

1. Technical Field

The present invention relates to an electro-optical device in which a lens is formed at a location overlapping a pixel electrode in plan view, an electro-optical device manufacturing method, and an electronic apparatus which includes the electro-optical device.

2. Related Art

In an electro-optical device (liquid crystal apparatus) which is used as the light valve or the like of a transmission-type liquid crystal apparatus, a liquid crystal layer is arranged between an element substrate, on which pixel electrodes and pixel switching elements are formed, and a counter substrate, on which common electrodes are formed. In the electro-optical device, an image is displayed by modulating light, which is incident on one side of the element substrate and the counter substrate in the liquid crystal layer. At this time, in the element substrate, only light that reaches a light transmission region (pixel opening region) that is surrounded by wirings or the like contributes to the display. Here, a configuration has been provided in which a plurality of lenses are formed at locations overlapping the plurality of respective pixel electrodes of the element substrate in plan view in the electro-optical device to which light is incident on a side of the element substrate. According to the configuration, it is possible to display a bright image (refer to JP-A-2015-34860). In addition, even in a case in which light is incident on the side of the counter substrate, if the plurality of lenses are formed at the locations overlapping the plurality of respective pixel electrodes of the element substrate in plan view in the counter substrate, it is possible to cause light which is emitted from the element substrate to be collimated, and thus it is possible to display a high-quality image.

In a case in which the electro-optical device disclosed in JP-A-2015-34860 is manufactured, after a lens surface, which includes a concave surface, is formed on a substrate which is larger than the element substrate, the lens layer is formed on the entire surface of the substrate. Thereafter, the lens is formed by flattening the surface of the lens layer.

However, since the lens layer is formed to cover the lens surface, the difference in thickness is large in the in-plane direction of the substrate. Therefore, if a heat treatment is performed in a process of forming a pixel switching element or the like, stress is generated due to the difference in thickness, and thus there is a problem in that cracks are generated in the lens layer. Cracks are not preferable because cracks may cause exfoliation or the like to occur between the lens layer and the substrate.

### SUMMARY

An advantage of some aspects of the invention is that an electro-optical device, which is capable of suppressing stress from occurring in a lens layer, an electro-optical device manufacturing method, and an electronic apparatus are provided.

According to an aspect of the invention, there is provided an electro-optical device including: a light-transmitting substrate on one surface of which a plurality of lens surfaces, which include concave surfaces or convex surfaces, are formed; a light-transmitting lens layer that covers the plurality of lens surfaces; a plurality of pixel electrodes that are provided on the lens layer on a side opposite to the substrate and are formed to overlap the plurality of respective lens surfaces in plan view; and a plurality of pixel switching elements that are provided on the lens layer on the side opposite to the substrate and are electrically connected to the plurality of respective pixel electrodes. A recess section that includes a concave-shaped lens forming region, in which the plurality of lens surfaces are arranged, is formed on one surface of the substrate. The plurality of lens surfaces are provided at a bottom of the recess section. The lens layer is provided such that an inner side of the recess section is filled. A surface of the lens layer on a side opposite to the substrate forms, on one surface of the substrate, a plane surface which is contiguous with an outside region positioned on an outer side of the recess section.

According to the aspect, the recess section that includes the concave-shaped lens forming region, in which the plurality of lens surfaces are arranged, is formed on one surface of the substrate, and the plurality of lens surfaces are provided at the bottom of the recess section. In addition, the lens layer is provided such that the inner side of the recess section is filled. Here, the surface of the lens layer on the side opposite to the substrate forms, on one surface of the substrate, the plane surface which is contiguous with the outside region positioned on the outer side of the recess section. The lens layer is not formed in the outside region. Therefore, the region, in which the lens layer is formed is limited, and thus it is difficult for a large stress to be generated in the lens layer even though a heat treatment is performed in a process step of forming the pixel switching elements or the like. It is possible to suppress a problem of cracks being generated in the lens layer or a problem of the lens layer being exfoliated from the substrate as a result of the cracks.

In the electro-optical device according to the aspect, at least some parts of adjacent lens surfaces of the plurality of lens surfaces may be connected to each other. According to the aspect, the plurality of lens surfaces may be respectively connected to other lens surfaces, which are positioned on the entire circumference. According to the aspect, it is possible to increase the amount of light incident on the lens surfaces. Here, in a case in which the adjacent lens surfaces are connected, the lens layer is formed on the entire surface of the substrate. However, according to the aspect, the lens layer is formed only inside the recess section. Therefore, it is difficult for stress to be generated in the lens layer even though the heat treatment is performed in the process step of forming the pixel switching elements or the like.

According to the aspect, a concave-shaped curved surface may be formed between a side surface and the bottom of the recess section. According to the aspect, it is difficult for stress to be concentrated on the lens layer which is positioned between the side surface and the bottom of the recess section even though the heat treatment is performed in the process step of forming the pixel switching elements or the like.

According to another aspect of the invention, there is provided an electro-optical device manufacturing method including: forming a recess section on one surface of a light-transmitting substrate; forming a plurality of lens surfaces that include concave surfaces or convex surfaces at a bottom of the recess section; forming a light-transmitting lens layer on one surface of the substrate such that an inside of the recess section is filled; flattening the lens layer from a side opposite to the substrate, and causing a surface of the lens layer on the side opposite to the substrate to form, on one surface of the substrate, a plane surface which is contiguous with an outside region positioned on an outer side of the recess section; and forming a plurality of pixel electrodes that overlap the plurality of respective lens surfaces in plan view and forming a plurality of pixel switching elements that are electrically connected to the plurality of respective pixel electrodes in the lens layer on the side opposite to the substrate.

According to the aspect, forming of the recess section may include performing wet etching on one surface in a state in which an etching mask is formed on one surface of the substrate. According to the aspect, the concave-shaped curved surface is formed between the side surface and the bottom of the recess section. Therefore, it is difficult for stress to be concentrated on the lens layer which is positioned between the side surface and the bottom of the recess section even though the heat treatment is performed in the process step of forming the pixel switching elements or the like.

The electro-optical device to which the invention is applied is used for various electronic apparatuses. In the invention, in a case in which the electro-optical device is used for a transmission-type liquid crystal apparatus from among the electronic apparatuses, the transmission-type liquid crystal apparatus is provided with a light-source section which emits light to be supplied to the electro-optical device and with a projection optical system which projects light that is modulated by the electro-optical device.

### BRIEF DESCRIPTION OF THE DRAWINGS

The invention will be described with reference to the accompanying drawings, wherein like numbers reference like elements.

FIG. 1 is a plan view illustrating an electro-optical device to which the invention is applied.

FIG. 2 is a sectional view illustrating the electro-optical device to which the invention is applied.

FIG. 3 is a plan view illustrating a plurality of pixels which are adjacent to each other in the electro-optical device to which the invention is applied.

FIG. 4 is a sectional view, taken along line IV-IV, illustrating the electro-optical device to which the invention is applied.

FIG. 5 is an explanatory view schematically illustrating the sectional configurations of lenses of the electro-optical device to which the invention is applied.

FIG. 6 is an explanatory view illustrating a planar positional relationship between the lenses and a light-shield layer of the electro-optical device to which the invention is applied.

FIG. 7 is an explanatory view illustrating a mother board which is used to manufacture an element substrate of the electro-optical device to which the invention is applied.

FIG. 8 is a sectional view illustrating process steps which indicate an element substrate manufacturing method of the electro-optical device to which the invention is applied.

FIG. 9 is a schematic configuration diagram illustrating a transmission-type liquid crystal apparatus (electronic apparatus) using the electro-optical device to which the invention is applied.

### DESCRIPTION OF EXEMPLARY EMBODIMENTS

Embodiments of the invention will be described with reference to the accompanying drawings. Meanwhile, in the drawings which are referred to in the description below, each layer and each member are shown at sizes which can be recognized in the drawing, and thus the scales thereof are different for each layer and each member. In addition, in the description below, in a case in which a layer which is formed on an element substrate is described, an upper layer side or a surface side means a side (side on which a counter substrate is located) opposite to a side on which the substrate is located, and a lower layer side means a side on which the substrate is located.

### Configuration of Electro-Optical Device

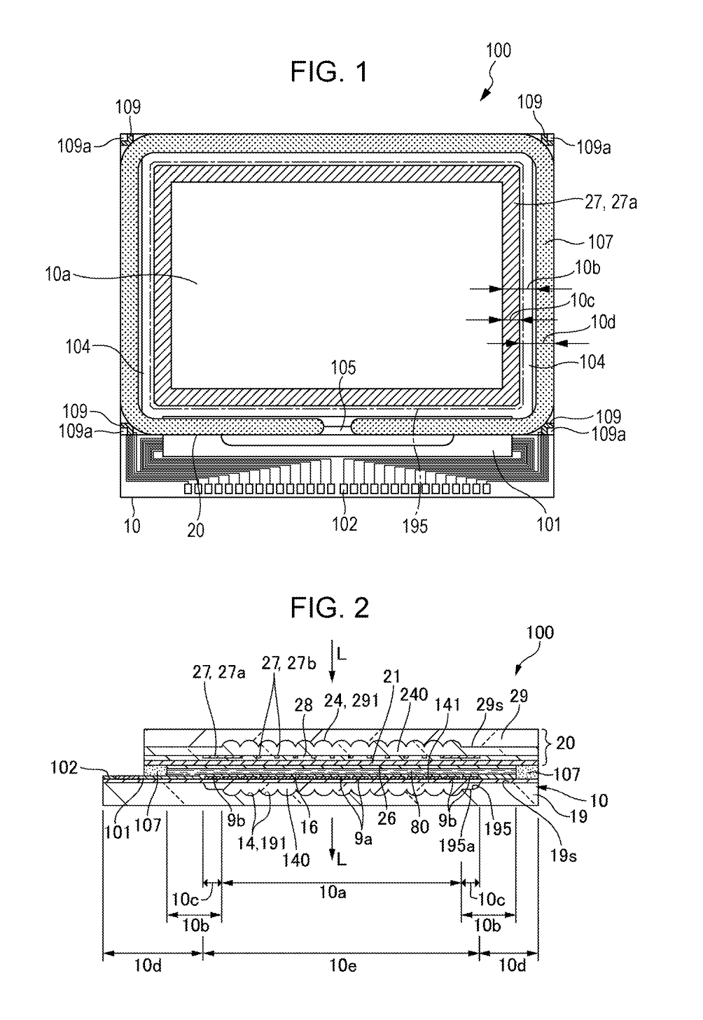

FIG. 1 is a plan view illustrating an electro-optical device 100 to which the invention is applied. FIG. 2 is a sectional view illustrating the electro-optical device 100 to which the invention is applied.

As illustrated in FIG. 1, in the electro-optical device 100, an element substrate 10 and a counter substrate 20 are bonded by a seal material 107 disposed in a predetermined gap, and the element substrate 10 faces the counter substrate 20. The seal material 107 is provided in a frame shape along the outer edge of the counter substrate 20, and an electro-optical layer 80, such as a liquid crystal layer, is arranged in a region which is surrounded by the seal material 107 between the element substrate 10 and the counter substrate 20. Accordingly, the electro-optical device 100 is formed as a liquid crystal apparatus. The seal material 107 is a photosetting adhesive, or a photosetting and thermosetting adhesive, and contains a gap material, such as glass fibers or glass beads, in order to set the distance between both of the substrates to a predetermined value.

Both the element substrate 10 and the counter substrate 20 have a square shape, and an image display region 10a is provided at approximately the center of the electro-optical device 100 as a square-shaped region. Accordingly, the seal material 107 is also provided in an approximately square shape, and a rectangular-shaped peripheral region 10b is provided between the inner periphery of the seal material 107 and the outer periphery of the display region 10a.

A data line drive circuit 101 and a plurality of terminals 102 are formed along one side of the element substrate 10 on the outside of the display region 10a on the surface of the element substrate 10 on the side of the counter substrate 20, and a scan line drive circuit 104 is formed along other sides which are adjacent to the one side. A flexible wiring substrate (not shown in the drawing) is connected to the terminals 102, and various potentials and various signals are input to the element substrate 10 via the flexible wiring substrate.

A plurality of light-transmitting pixel electrodes 9a, which include Indium Tin Oxide (ITO) films or the like, and pixel switching elements (not shown in the drawing), which are electrically connected to the plurality of respective pixel electrodes 9a, are formed in a matrix shape in the display region 10a on the surface of the element substrate 10 on the side of the counter substrate 20. A first oriented film 16 is formed on the pixel electrodes 9a on the side of the counter substrate 20, and the pixel electrodes 9a are covered by the first oriented film 16.

A light-transmitting common electrode 21, which includes an ITO film, is formed on the side of a surface of the counter substrate 20 which faces the element substrate 10, and a second oriented film 26 is formed on the common electrode 21 on the side of the element substrate 10. The common electrode 21 is formed on approximately the entire surface of the counter substrate 20 and is covered by the second oriented film 26. A light-shading light-shield layer 27, which is formed of a metal or a metal compound, is formed on the common electrode 21 on a side opposite to the element substrate 10. The light-shield layer 27 is formed, for example, as a divider 27a in a frame shape, which extends along the outer periphery of the display region 10a. In addition, the light-shield layer 27 is also formed as a light-shield layer 27b in a region which overlaps with a region interposed by adjacent pixel electrodes 9a in plan view. In the embodiment, dummy pixel electrodes 9b, which are simultaneously formed with the pixel electrodes 9a, are formed in a dummy pixel region 10c which overlaps the divider 27a in the peripheral region 10b of the element substrate 10.

The first oriented film 16 and the second oriented film 26 are formed of an inorganic oriented film (vertical oriented film) that includes a diagonally vapor-deposited film, such as SiOₓ (x<2), SiO₂, TiO₂, MgO, or Al₂O₃, and cause liquid crystal molecules having negative dielectric anisotropy, which is used for the electro-optical layer 80, to be aligned at an incline. Therefore, the liquid crystal molecules form a predetermined angle for the element substrate 10 and the counter substrate 20. In this manner, the electro-optical device 100 is formed as a liquid crystal apparatus in a Vertical Alignment (VA) mode.

In the element substrate 10, inter-substrate conduction electrodes 109 are formed in regions, which overlap the corner parts of the counter substrate 20 on the outer side of the seal material 107, in order to enable electrical conduction between the element substrate 10 and the counter substrate 20. In the inter-substrate conduction electrodes 109, inter-substrate conduction materials 109a, which include conductive particles, are arranged. The common electrode 21 of the counter substrate 20 is electrically connected to the side of the element substrate 10 via the inter-substrate conduction materials 109a and the inter-substrate conduction electrodes 109. Therefore, a common potential is applied to the common electrode 21 from the side of the element substrate 10.

In the electro-optical device 100 of the embodiment, the pixel electrode 9a and the common electrode 21 are formed of the ITO film (light-transmitting conductive film), and the electro-optical device 100 is formed as a transmission-type liquid crystal apparatus. In the electro-optical device 100, an image is displayed in such a way that light, which is incident on one of the element substrate 10 and the counter substrate 20, is modulated when the light passes through the other-side substrate and is then emitted. In the embodiment, as illustrated by arrow L, an image is displayed in such a way that light, which is incident on the counter substrate 20, is modulated by the electro-optical layer 80 for each pixel when the light passes through the element substrate 10 and is emitted.

### Detailed Configuration of Pixel

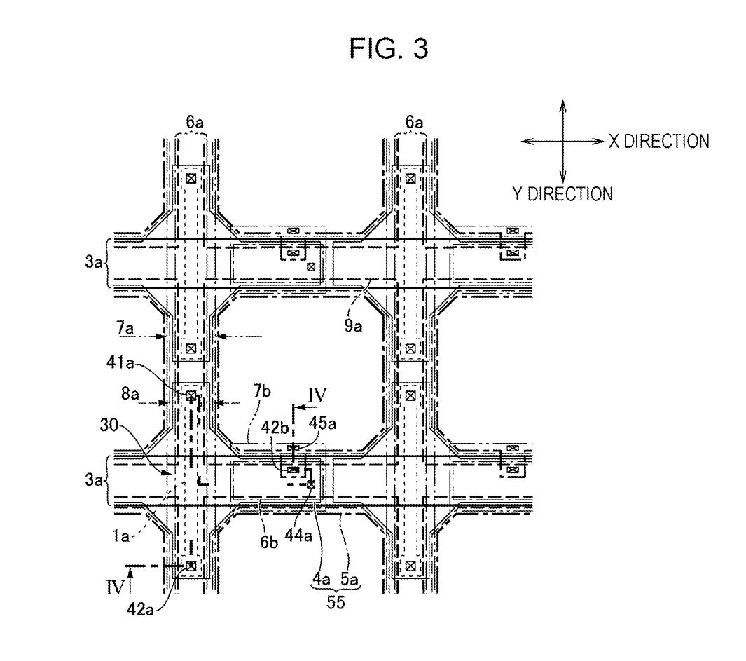

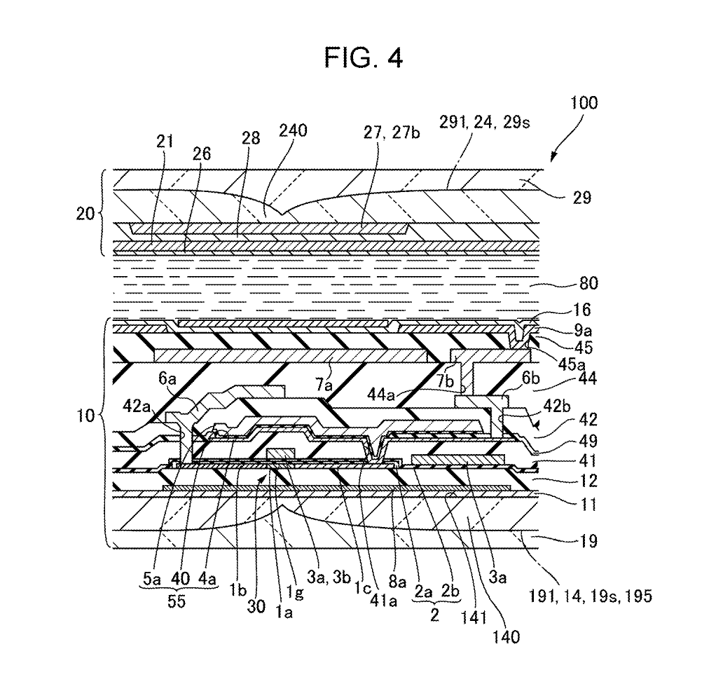

FIG. 3 is a plan view illustrating a plurality of pixels which are adjacent to each other in the electro-optical device 100 to which the invention is applied. FIG. 4 is a sectional view, taken along line IV-IV, illustrating the electro-optical device 100 to which the invention is applied. Meanwhile, in FIG. 3, respective layers are indicated by the lines described below. In addition, in FIG. 3, with regard to layers which have terminals overlapping each other in plan view, the positions of the terminals are shifted such that the shapes or the like of the layers are easily understood.

Thin long broken line denotes a lower layer-side light-shield layer 8a.

Thin and short dotted line denotes a semiconductor layer 1a.

Thick solid line denotes a scan line 3a.

Thin solid line denotes a drain electrode 4a.

Thin one-dot chain line denotes a data line 6a and a relay electrode 6b.

Thick one-dot chain line denotes a capacitance line 5a.

Thin two-dot chain line denotes an upper layer-side light-shield layer 7a and a relay electrode 7b.

Thick broken line denotes the pixel electrode 9a.

As illustrated in FIG. 3, the pixel electrodes 9a are formed in the respective plurality of pixels on the surface of the element substrate 10, which faces the counter substrate 20, and the data lines 6a and the scan lines 3a are formed along inter pixel regions interposed by the adjacent pixel electrodes 9a. The inter-pixel regions extend horizontally and vertically, the scan lines 3a extend linearly along a first inter-pixel region of the inter-pixel regions, which extends in the X direction, and the data lines 6a extend linearly along a second inter-pixel region which extends in the Y direction. In addition, pixel switching elements 30 are formed to correspond to the intersections of the data lines 6a and the scan lines 3a. In the embodiment, the pixel switching elements 30 are formed by intersection regions between the data lines 6a and the scan lines 3a and the vicinity thereof. The capacitance lines 5a are formed in the element substrate 10, and a common potential Vcom is applied to the capacitance lines 5a. The capacitance lines 5a are formed in a lattice shape in such a manner to overlap the scan lines 3a and the data lines 6a. The upper layer-side light-shield layer 7a is formed on the upper layer side of the pixel switching elements 30, and the upper layer-side light-shield layer 7a extends to overlap the data lines 6a and the scan lines 3a. The lower layer-side light-shield layer 8a is formed on the lower layer side of the pixel switching elements 30, and the lower layer-side light-shield layer 8a extends to overlap the scan lines 3a and the data lines 6a.

As illustrated in FIG. 4, the substrate main body of the element substrate 10 is formed of a light-transmitting substrate 19, such as a quartz substrate or a glass substrate, and the pixel electrode 9a, the pixel switching element 30 for pixel switching, a first oriented film 16, and the like are formed on a surface (the side of one surface 19s which faces the counter substrate 20) of the substrate 19 on the side of the electro-optical layer 80, as will be described later. In addition, the substrate main body of the counter substrate 20 is formed of a light-transmitting substrate 29, such as the quartz substrate or the glass substrate, and the light-shield layer 27, the common electrode 21, the second oriented film 26, and the like are formed on the surface (one surface 29s which faces the element substrate 10) of the substrate 29 on the side of the electro-optical layer 80 of the substrate 29, as will be described below.

In the element substrate 10, a protective layer 11, which includes a silicon oxide film, is formed on the side of one surface 19s of the substrate 19, and the lower layer-side light-shield layer 8a, which includes a conductive film such as a conductive polysilicon film, a metal silicide film, a metal film or a metal compound film, is formed on the upper layer of the protective layer 11. In the embodiment, the lower layer-side light-shield layer 8a is formed of a light-shield film, such as tungsten silicide (WSi), tungsten, or titanium nitride, thereby preventing reflected light from being incident on the semiconductor layer 1a and preventing a malfunction attributable to photoelectric current from occurring in the pixel switching element 30 in a case in which light that passes through the electro-optical device 100 is reflected in another member. There is a case in which the lower layer-side light-shield layer 8a is formed as the scan lines. In this case, the lower layer-side light-shield layer 8a is formed to enable electrical conduction between a gate electrode 3b, which will be described later, and the lower layer-side light-shield layer 8a.

A light-transmitting insulation film 12, which includes a silicon oxide film, is formed on the upper layer side of the lower layer-side light-shield layer 8a on the side of the one surface 19s of the substrate 19, and the pixel switching element 30, which includes the semiconductor layer 1a, is formed on the upper layer side of the insulation film 12. The pixel switching element 30 includes the semiconductor layer 1a, in which a long-side direction faces the extension direction of the data line 6a, and the gate electrode 3b, which extends in a direction orthogonal to the longitudinal direction of the semiconductor layer 1a and overlaps the central part of the longitudinal direction of the semiconductor layer 1a. In the embodiment, the gate electrode 3b includes a part of the scan line 3a. The pixel switching element 30 includes a light-transmitting gate insulation layer 2 between the semiconductor layer 1a and the gate electrode 3b. The semiconductor layer 1a includes a channel region 1g, which faces the gate electrode 3b through the gate insulation layer 2, and includes a source region 1b and a drain region 1c on both sides of the channel region 1g. In the embodiment, the pixel switching element 30 has an LDD structure. Accordingly, the source region 1b and the drain region 1c respectively include low concentration regions on both sides of the channel region 1g and include high-concentration regions in regions which are adjacent to the channel region 1g on the side opposite to the low concentration regions.

The semiconductor layer 1a is formed of a polysilicon film (polycrystalline silicon film) or the like. The gate insulation layer 2 includes a two-layered structure which includes a first gate insulation layer 2a that is formed of a silicon oxide film acquired by performing thermal oxidation on the semiconductor layer 1a, and a second gate insulation layer 2b that is formed of a silicon oxide film formed by a decompression CVD method or the like. The gate electrode 3b and the scan line 3a include a conductive film such as a conductive polysilicon film, a metal silicide film, a metal film, or a metal compound film.

A light-transmitting inter-layer insulation film 41, which includes the silicon oxide film, is formed on the upper layer side of the gate electrode 3b, and the drain electrode 4a is formed on the upper layer of the inter-layer insulation film 41. The drain electrode 4a includes the conductive film such as the conductive polysilicon film, the metal silicide film, the metal film, or the metal compound film. The drain electrode 4a is formed such that a part of the drain electrode 4a overlaps the drain region 1c of the semiconductor layer 1a and the drain electrode 4a is electrically connected to the drain region 1c through a contact hole 41a which passes through the inter-layer insulation film 41 and the gate insulation layer 2.

A light-transmitting etching stopper layer 49 and a light-transmitting dielectric layer 40, which include a silicon oxide film or the like, are formed on the upper layer side of the drain electrode 4a, and the capacitance line 5a is formed on the upper layer side of the dielectric layer 40. It is possible to use a silicon compound, such as a silicon oxide film or a silicon nitride film, as the dielectric layer 40. In addition, it is possible to use a dielectric layer, which has a high dielectric constant, such as an aluminum oxide film, a titanium oxide film, a tantalium oxide film, a niobium oxide film, a hafnium oxide film, a lanthanum oxide film, or a zirconium oxide film. The capacitance line 5a includes a conductive film, such as a conductive polysilicon film, a metal silicide film, a metal film, or a metal compound film. The capacitance line 5a overlaps the drain electrode 4a through the dielectric layer 40 and forms a maintenance capacitance 55.

A light-transmitting inter-layer insulation film 42, which includes a silicon oxide film or the like, is formed on the upper layer side of the capacitance line 5a, and the data line 6a and the relay electrode 6b are formed by the same conductive film on the upper layer side of the inter-layer insulation film 42. The data line 6a and the relay electrode 6b include the conductive film such as the conductive polysilicon film, the metal silicide film, the metal film or the metal compound film. The data line 6a is electrically connected to the source region 1b through the contact hole 42a which passes through the inter-layer insulation film 42, the etching stopper layer 49, the inter-layer insulation film 41, and the gate insulation layer 2. The relay electrode 6b is electrically connected to the drain electrode 4a through the contact hole 42b which passes through the inter-layer insulation film 42 and the etching stopper layer 49.

A light-transmitting inter-layer insulation film 44, which includes the silicon oxide film, is formed on the upper layer side of the data line 6a and the relay electrode 6b, and the upper layer-side light-shield layer 7a and the relay electrode 7b are formed by the same conductive film on the upper layer side of the inter-layer insulation film 44. The surface of the inter-layer insulation film 44 is flattened. The upper layer-side light-shield layer 7a and the relay electrode 7b include the conductive film such as the conductive polysilicon film, the metal silicide film, the metal film, or the metal compound film. The relay electrode 7b is electrically connected to the relay electrode 6b through a contact hole 44a which passes through the inter-layer insulation film 44. The upper layer-side light-shield layer 7a extends to overlap the data line 6a and functions as a light-shield layer. Meanwhile, the upper layer-side light-shield layer 7a may be electrically connected to the capacitance line 5a and may be used as a shield layer.

A light-transmitting inter-layer insulation film 45, which includes the silicon oxide film or the like, is formed on the upper layer side of the upper layer-side light-shield layer 7a and the relay electrode 7b, and the pixel electrode 9a, which includes the ITO film, is formed on the upper layer side of the inter-layer insulation film 45. The contact hole 45a, which reaches the relay electrode 7b, is formed in the inter-layer insulation film 45, and the pixel electrode 9a is electrically connected to the relay electrode 7b through the contact hole 45a. As a result, the pixel electrode 9a is electrically connected to the drain region 1c through the relay electrode 7b, the relay electrode 6b, and the drain electrode 4a. The surface of the inter-layer insulation film 45 is flattened. The light-transmitting first oriented film 16, which includes a polyimide or an inorganic oriented film, is formed on the surface side of the pixel electrode 9a.

### Configuration of Counter Substrate

In the counter substrate 20, the light-shield layer 27, the protective layer 28, which includes the silicon oxide film or the like, and the common electrode 21, which includes the light-transmitting conductive film such as the ITO film, are formed on the surface (one surface 29s which faces the element substrate 10) of the light-transmitting substrate 29 (light-transmitting substrate), such as the quartz substrate or the glass substrate, on the side of the electro-optical layer 80, and the light-transmitting second oriented film 26, which includes the polyimide and the inorganic oriented film, is formed to cover the common electrode 21. In the embodiment, the common electrode 21 includes the ITO film.

### Configuration of Lens on Side of Counter Substrate

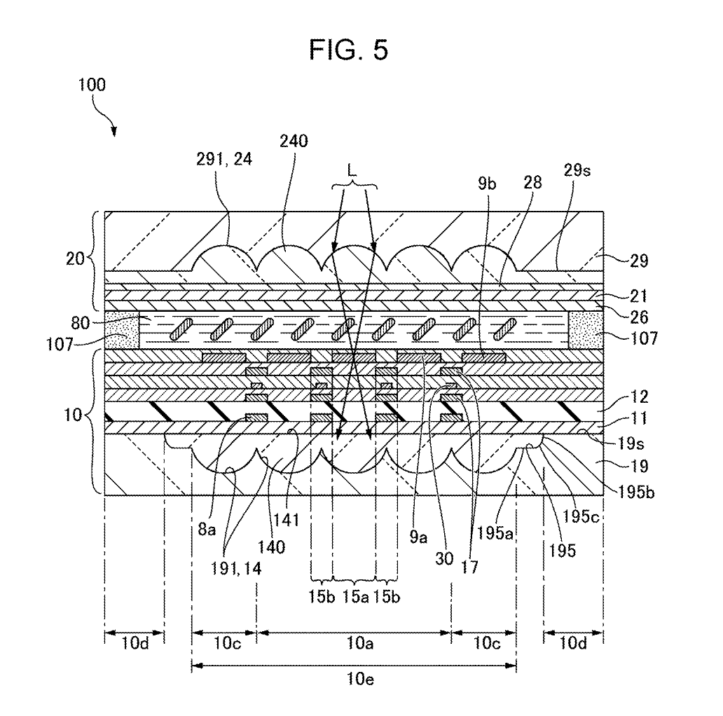

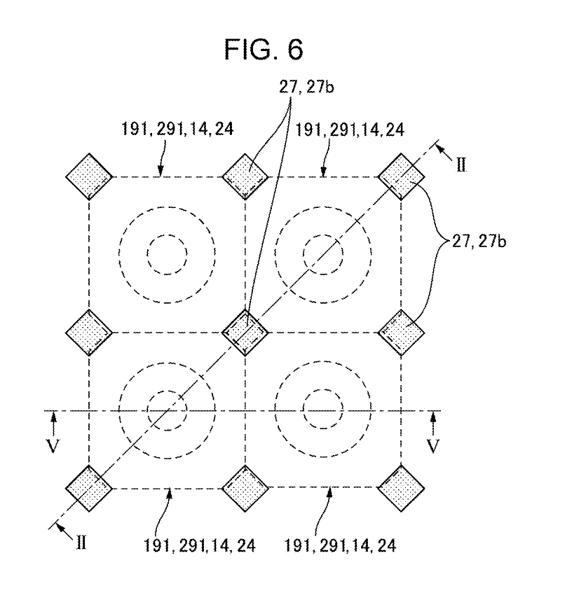

FIG. 5 is an explanatory view schematically illustrating the sectional configurations of lenses 14 and 24 of the electro-optical device 100 to which the invention is applied. FIG. 6 is an explanatory view illustrating a planar positional relationship between the lenses 14 and 24 and the light-shield layer 27b of the electro-optical device 100 to which the invention is applied.

As illustrated in FIG. 5, in the element substrate 10, the light-shield layer 17 and the pixel switching element 30, which include the data line 6a and the like, are formed on the side of the one surface 19s of the substrate 19. Light does not pass through the light-shield layer 17 and the pixel switching element 30. Therefore, in the element substrate 10, from among the regions which overlap the pixel electrodes 9a in a plan view, regions, which overlap the light-shield layer 17 and the pixel switching elements 30 in a plan view, and regions, which overlap regions interposed between adjacent pixel electrodes 9a in a plan view, become light-shield regions 15b through which light does not pass. In contrast, from among the regions which overlap the pixel electrodes 9a in a plan view, a region which does not overlap the light-shield layer 17 and the pixel switching elements 30 in a plan view is an opening region 15a (light transmission regions) through which light passes. Accordingly, only light which passes through the opening region 15a contributes to display an image, and light which faces the light-shield regions 15b does not contribute to display the image.

Here, in the embodiment, a plurality of lenses 24, which respectively overlap the plurality of pixel electrodes 9a in a plan view with one-to-one relationship, are formed in the counter substrate 20. The lenses 24 collimate light which is incident into the electro-optical layer 80. Therefore, since the inclination of the optical axis of light which is incident into the electro-optical layer 80 is small, it is possible to reduce phase deviation in the electro-optical layer 80, and thus it is possible to suppress the decrease of transmittance and contrast. In particular, in the embodiment, the electro-optical device 100 is formed as the liquid crystal apparatus in the VA mode, and thus the decrease or the like of contrast easily occurs according to the inclination of the optical axis of light which is incident into the electro-optical layer 80. However, according to the embodiment, it is difficult for the decrease in contrast or the like to occur.

As illustrated in FIG. 6, the lenses 24 are arranged such that at least some parts of the adjacent lenses 24 come into contact with each other. In the embodiment, the lenses 24 come into contact with neighboring lenses 24 on the entire circumference, and the light-shield layer 27b, illustrated in FIG. 2, is formed in a region which overlaps a region surrounded by the four lenses 24 in a plan view. Therefore, in FIG. 2, the light-shield layer 27b is illustrated as a cross section taken along a line II-II of FIG. 6. However, in FIG. 5, the light-shield layer 27b is not illustrated as a cross section taken along a line V-V of FIG. 6.

In a case in which the counter substrate 20 is formed, a plurality of lens surfaces 291, which include concave surfaces that overlap the plurality of respective pixel electrodes 9a in a plan view with one-to-one relationship, are formed on one surface 29s of the substrate 29. In addition, a light-transmitting lens layer 240 and a light-transmitting protective layer 28 are sequentially laminated on one surface 29s of the substrate 29, and the common electrode 21 is formed on the protective layer 28 on a side opposite to the substrate 29. The substrate 29 and the lens layer 240 have different refractive indexes, and lens surfaces 291 and the lens layer 240 form the lenses 24. In the embodiment, the refractive index of the lens layer 240 is larger than the refractive index of the substrate 29. For example, the substrate 29 includes a quartz substrate (silicon oxide, SiO2) and a refractive index is 1.48. In contrast, the lens layer 240 includes a silicon oxinitride film (SiON) and the refractive index is included between 1.58 and 1.68. Therefore, the lenses 24 have power to converge light from light sources.

### Configuration of Lens on Side of Element Substrate

As illustrated in FIG. 5, in the embodiment, a plurality of lens lenses 14, which overlap the plurality of respective pixel electrodes 9a in a plan view with one-to-one relationship, are formed on the element substrate 10, similarly to the counter substrate 20, and the lenses 14 collimate light which is emitted from the element substrate 10. Therefore, according to the embodiment, it is difficult for the decrease of contrast to occur.

As illustrated in FIG. 6, similarly to the lenses 24, the lenses 14 are arranged such that at least some parts of the adjacent lenses 14 come into contact with each other. In the embodiment, the lenses 14 come into contact with neighboring lenses 14 on the entire circumference.

In a case in which the element substrate 10 is formed, a plurality of lens surfaces 191, which include concave surfaces that overlap the plurality of respective pixel electrodes 9a in a plan view with one-to-one relationship, are formed on one surface 19s of the substrate 19. In addition, the light-transmitting lens layer 140 is laminated on the one surface 19s of the substrate 19, and the protective layer 11, the lower layer-side light-shield layer 8a, the insulation film 12, and the like are sequentially formed on the lens layer 140 on a side opposite to the substrate 19. The substrate 19 and the lens layer 140 have different refractive indexes, and the lens surfaces 191 and the lens layer 140 form the lenses 14. In the embodiment, the refractive index of the lens layer 140 is larger than the refractive index of the substrate 19. For example, substrate 19 includes the quartz substrate (silicon oxide, SiO2) and the refractive index is 1.48. In contrast, the lens layer 140 includes a silicon oxinitride film (SiON) and the refractive index is included between 1.58 and 1.68. Therefore, the lenses 14 have power to converge light.

Here, a recess section 195 that includes a concave-shaped whole lens forming region 10e, in which the plurality of lens surfaces 191 are arranged, is formed on one surface 19s of the substrate 19, and the plurality of lens surfaces 191 are provided at the bottom 195a of the recess section 195. Therefore, the lens layer 140 is provided to cause the inner side of the recess section 195 to be filled. In addition, the surface 141 of the lens layer 140 on a side opposite to the substrate 19 forms a plane surface which is contiguous to the outside region 10d that is positioned on the outer side of the recess section 195 on the one surface 19s of the substrate 19. Therefore, the lens layer 140 is not formed on the outside region 10d of the substrate 19, and the outside region 10d of the substrate 19 is exposed from the lens layer 140. In the embodiment, the lenses 14 are formed at locations overlapping the pixel electrodes 9a in the display region 10a and regions overlapping the dummy pixel electrodes 9b in the dummy pixel region 10c. Therefore, the lens forming region 10e includes the display region 10a and the dummy pixel region 10c, and the recess section 195 are formed in a region which includes the display region 10a and the dummy pixel region 10c.

In the embodiment, the concave-shaped curved surface 195c is formed between the side surface 195b and the bottom 195a of the recess section 195, and the side surface 195b and the bottom 195a of the recess section 195 are connected by the contiguous surface.

### Electro-Optical Device Manufacturing Method

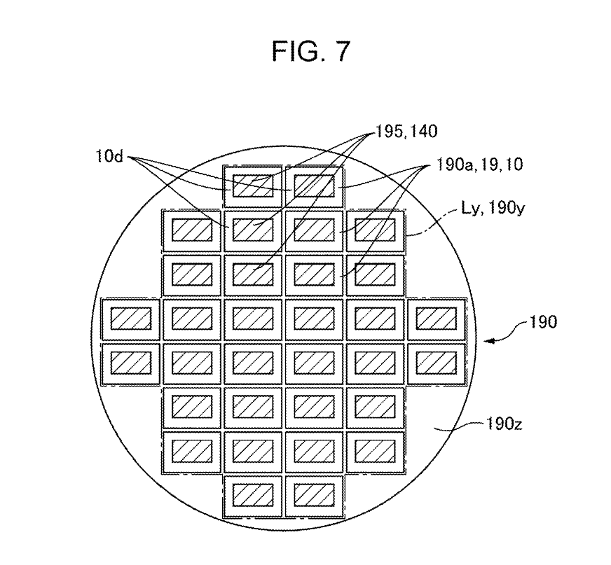

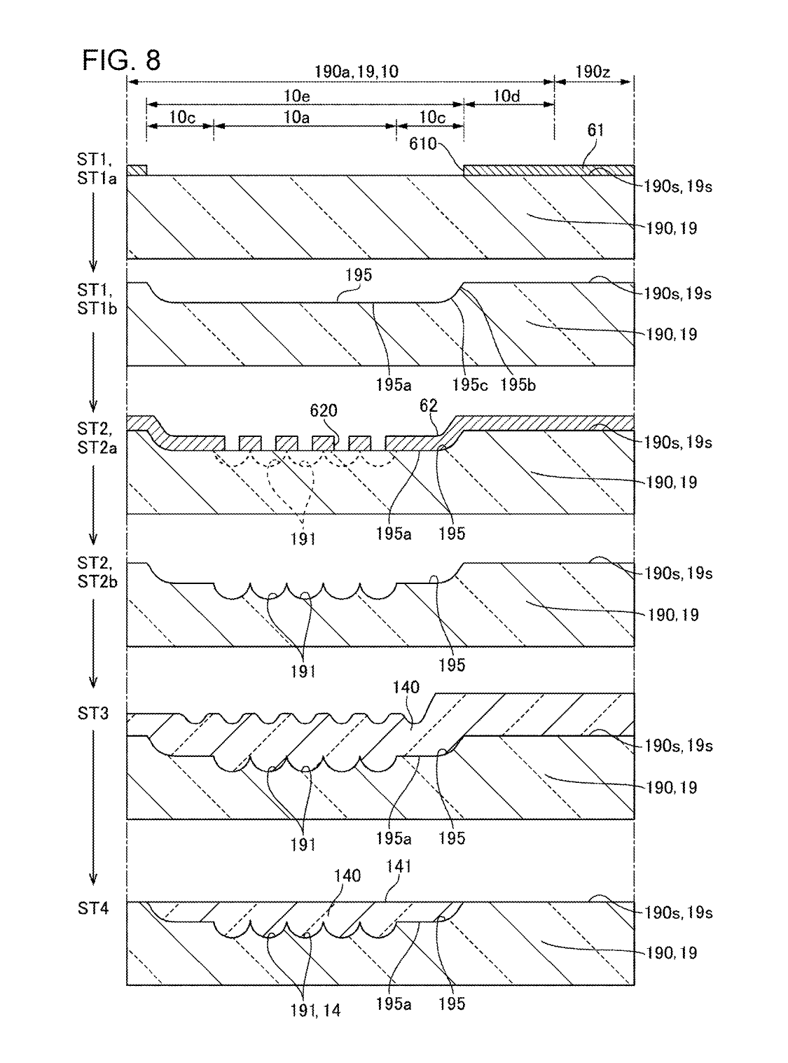

FIG. 7 is an explanatory view illustrating a mother board 190 which is used to manufacture the element substrate 10 of the electro-optical device 100 to which the invention is applied. FIG. 8 is a sectional view illustrating process steps which indicate a method of manufacturing the element substrate 10 of the electro-optical device 100 to which the invention is applied.

As illustrated in FIG. 7, in a case in which the element substrate 10 according to the embodiment is manufactured, the mother board 190, which includes a quartz substrate that is larger than the substrate 19, is used. The mother board 190 includes a plurality of regions 190a which are cut as the element substrates 10 (substrates 19). After the lenses 14, the pixel switching elements 30, the pixel electrodes 9a, and the like, which have been described with reference to FIG. 2, are formed on the regions 190a, the mother board 190 is cut along the regions 190a, thereby acquiring the element substrate 10 of a single-unit size. Accordingly, in the mother board 190, a region (region which is surround by a dashed line Ly), in which the plurality of element substrates 10 are cut, is an available region 190y, and the other region is a removal material region 190z which is removed in a cutting process step.

In a case in which the element substrate 10 is manufactured using the mother board 190, the following process steps and the like are performed in the embodiment.

Recess section forming process step ST1
Lens surface forming process step ST2
Lens layer forming process step ST3
Flattening process step ST4
Pixel forming process step

First, in the recess section forming process step ST1 illustrated in FIG. 8, the recess section 195 is formed on one surface 190s (one surface 19s) of the mother board 190 (substrate 19). More specifically, in a mask forming process step ST1a, an etching mask 61 is formed on one surface 190s of the mother board 190. In the embodiment, the pixel electrode 9a and the dummy pixel region 10c are the lens forming region 10e, and a region which includes the lens forming region 10e becomes an opening section 610 in the etching mask 61. Subsequently, in an etching process step ST1b, one surface 190s of the mother board 190 is etched from the opening section 610 of the etching mask 61, thereby forming the recess section 195. Thereafter, the etching mask 61 is removed. As a result, as illustrated in regions which are filled with oblique lines in FIG. 7, the recess sections 195 are independently formed in the respective regions 190a in which the plurality of element substrates 10 are cut.

In the etching process step Snip, either wet etching or dry etching may be used. In the embodiment, in the etching process step Snip, the wet etching is used using etchant which includes hydrofluoric acid. Therefore, the concave-shaped curved surface 195c is formed between the side surface 195b and the bottom 195a of the recess section 195, and the side surface 195b and the bottom 195a of the recess section 195 are connected by the contiguous surface.

Subsequently, in the lens surface forming process step ST2 illustrated in FIG. 8, the plurality of lens surfaces 191, which includes a concave surface, is formed at the bottom 195a of the recess section 195. Specifically, in a mask forming process step ST2a, an etching mask 62, in which regions overlapping the centers of the lens surfaces 191 in a plan view become opening sections 620, is formed on one surface 190s of the mother board 190. Subsequently, in an etching process step ST2b, isotropic etching is performed on the bottom 195a of the recess section 195 from the opening sections 620. As a result, the lens surfaces 191 which include the concave surfaces, in which the opening sections 620 are the center, are formed on one surface 190s of the mother board 190. Thereafter, the etching mask 62 is removed. In the etching process step ST2b, either the wet etching or the dry etching may be used. In the embodiment, in the etching process step ST2b, the wet etching is used using etchant which includes hydrofluoric acid.

Subsequently, in the lens layer forming process step ST3 illustrated in FIG. 8, the light-transmitting lens layer 140 is formed on one surface 190s of the mother board 190 such that the inner side of the recess section 195 to be filled. In the embodiment, the lens layer 140 includes silicon oxinitride film (SiON) which is formed by the plasma CVD or the like. Accordingly, in a case in which the plasma CVD is performed, for example, monosilane (SiH4) and nitric monoxide (N2O) are used as source gas. Meanwhile, there is a case in which ammonia (NH3) is used as the source gas.

Subsequently, in the flattening process step ST4 illustrated in FIG. 8, the lens layer 140 is flattened from a side opposite to the mother board 190, and the surface 141 of the lens layer 140 on a side opposite to the mother board 190 is caused to be a plane surface which is contiguous to the outside region 10d that is positioned on the outside of the recess section 195 on the one surface 190s of the mother board 190. As a result, the lens layer 140 is removed from the region other than the recess section 195. Therefore, as illustrated in regions which are filled with oblique lines in FIG. 7, the lens layers 140 are independently formed within the recess sections 195 in the respective region in which the plurality of element substrates 10 are cut. In the embodiment, a Chemical Mechanical Polishing (CMP) process or the like is used as a flattening process. In this case, after the lens layer 140, which is formed in the outside region 10d of the recess section 195, is caused to be thin, the region (lens forming region 10e), which overlaps the recess section 195, and the surface of the lens layer 140, which remains in the outside region 10d, may be flattened, and the lens layer 140 may be removed from the outside region 10d. In addition, the deformation of the lens layer 140 in a case in which the heating process is performed may be suppressed by performing heading and flattening processes again after the surface of the lens layer 140 is flattened.

Thereafter, as illustrated in FIG. 4, after the protective layer 11, which includes the silicon oxide film or the like, is formed on the side of the one surface 19s of the substrate 19, the plurality of pixel switching elements 30, the pixel electrodes 9a, and the like are formed in the pixel forming process step. Thereafter, after the mother board 190 is bonded to the counter substrate 20, the electro-optical layer 80 is injected between the mother board 190 and the counter substrate 20, and then the mother board 190 is cut.

### Main Advantage of Embodiment

As described above, in the element substrate 10 which is used for the electro-optical device 100 according to the embodiment, the recess section 195 is formed on one surface 19s of the substrate 19, and the plurality of lens surfaces 191 are provided at the bottom of the recess section 195. In addition, the lens layer 140 is provided such that the inner side of the recess section 195 is filled. Here, the surface 141 of the lens layer 140 on a side opposite to the substrate 19 forms a plane surface which is contiguous to the outside region 10d that is positioned on the outer side of the recess section 195 on one surface 19s of the substrate 19, and the lens layer 140 is not formed in the outside region 10d. Therefore, in the mother board 190 illustrated in FIG. 7, the region in which the lens layer 140 is formed is limited. Accordingly, even in a case in which the difference in film thickness is large in the lens layer 140, the lens layer 140 is formed by being separated in a plurality of spots, and thus, even in a case in which heat treatment is performed in a process step of forming the pixel switching elements 30 or the like, it is difficult for a large stress to be generated in the lens layer 140. Accordingly, it is possible to suppress a problem of cracks being generated in the lens layer 140 or a problem of the lens layer 140 being exfoliated from the substrate 19 as a result of the cracks.

In addition, since the recess section 195 is formed by the wet etching, the concave-shaped curved surface 195c is formed between the side surface 195b and the bottom 195a of the recess section 195. Therefore, even in a case in which the heat treatment is performed in the process step of forming the pixel switching elements 30 or the like, it is difficult for a large stress to be generated in the lens layer 140. Accordingly, it is possible to suppress the problem of cracks being generated in the lens layer 140 and the problem of the lens layer 140 being exfoliated from the substrate 19 as a result of the cracks.

In the embodiment, at least some parts of the adjacent lens surfaces 191 from among the plurality of lens surfaces 191 are connected. In particular, in the embodiment, each of the plurality of lens surfaces 191 is connected to the lens surfaces 191, which are positioned around, on the entire circumference. Therefore, it is possible to increase the amount of light which is incident into the lens surfaces 191. Here, in a case in which the adjacent lens surfaces 191 are connected, the lens layer 140 is formed on the entire surface of the substrate 19. However, in the embodiment, the lens layer 140 is provided only inside the recess section 195. Therefore, even in a case in which the heat treatment is performed in the process step of forming the pixel switching elements 30 or the like, it is difficult for stress to be generated in the lens layer 140.

### Modified Example of Embodiment

In the above embodiments, the lenses 14 are formed in the display region 10a and the dummy pixel region 10c. However, the lenses 14 may be formed in only the display region 10a.

In the above embodiments, the lens surfaces 191, which include the concave surfaces, are formed. However, the invention may be applied to a case in which lens surfaces, which include convex surfaces, are formed. In the above embodiments, the invention is applied to the electro-optical device 100 in a type in which light is incident from the side of the counter substrate 20. However, the invention may be applied to the electro-optical device 100 in a type in which light is incident from the side of the element substrate 10.

### Mounting Example on Electronic Apparatus

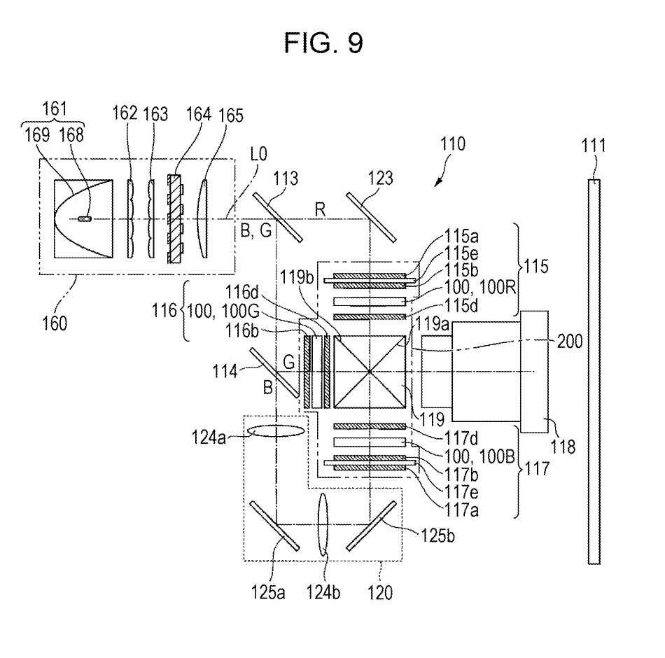

FIG. 9 is a schematic configuration diagram illustrating a transmission-type liquid crystal apparatus (electronic apparatus) using the electro-optical device 100 to which the invention is applied. Meanwhile, in the description below, a plurality of electro-optical devices 100, to which light having different wavelength regions is supplied, are used. However, the electro-optical device 100 to which the invention is applied is used for all of the electro-optical devices 100.

The transmission-type liquid crystal apparatus 110 illustrated in FIG. 9 is a liquid crystal projector using the transmission-type electro-optical device 100, and displays an image by irradiating light to a projecting member 111 which includes a screen or the like. The transmission-type liquid crystal apparatus 110 includes, along an optical axis L0 of the apparatus, a lighting device 160, a plurality of electro-optical devices 100 (liquid crystal light valves 115 to 117) to which light emitted from the lighting device 160 is supplied, a cross dichroic prism 119 (photosynthetic optical system) which synthesizes and emits light that is emitted from the plurality of electro-optical devices 100, and a projection optical system 118 which projects light synthesized by the cross dichroic prism 119. In addition, the transmission-type liquid crystal apparatus 110 includes dichroic mirrors 113 and 114, and a relay system 120. In the transmission-type liquid crystal apparatus 110, the electro-optical device 100 and the cross dichroic prism 119 form an optical unit 200.

In the lighting device 160, along the optical axis L0 of the apparatus, a light-source section 161, a first integrator lens 162, which includes a lens array such as a fly-eye lens, a second integrator lens 163, which includes a lens array such as a fly-eye lens, a polarized light conversion element 164, and a condenser lens 165 are sequentially arranged. The light-source section 161 includes a light source 168 which emits white light including red light R, green light G and blue light B, and a reflector 169. The light source 168 is formed of an extra-high pressure mercury lamp or the like, and the reflector 169 includes a parabolic cross section. The first integrator lens 162 and the second integrator lens 163 equalize the luminance distribution of light emitted from the light-source section 161. The polarized light conversion element 164 causes light emitted from the light-source section 161 to be polarized light which has a specific vibration direction similar to, for example, s-polarized light.

A dichroic mirror 113 causes red light R, which is included in light emitted from the lighting device 160, to pass therethrough, and reflects green light G and blue light B. A dichroic mirror 114 causes blue light B of green light G and blue light B, which are reflected in the dichroic mirror 113, to pass therethrough, and reflects green light G. As above, the dichroic mirrors 113 and 114 form a color separation optical system which separates light emitted from the lighting device 160 into red light R, green light G, and blue light B.

A liquid crystal light valve 115 is a transmission-type liquid crystal apparatus that modulates red light R, which passes through the dichroic mirror 113 and is reflected in a reflection mirror 123, according to an image signal. The liquid crystal light valve 115 includes a λ/2 phase difference plate 115a, a first polarizing plate 115b, an electro-optical device 100 (red electro-optical device 100R), and a second polarizing plate 115d. Here, even in a case in which red light R, which is incident into the liquid crystal light valve 115, passes through the dichroic mirror 113, polarized light is not changed, and thus s-polarized light is not changed.

The λ/2 phase difference plate 115a is an optical element that converts s-polarized light which is incident into the liquid crystal light valve 115 into p-polarized light. The first polarizing plate 115b is a polarizing plate that cuts off s-polarized light and causes p-polarized light to pass therethrough. The electro-optical device 100 (red electro-optical device 100R) is formed to convert p-polarized light into s-polarized light (in a case of halftone, circularly polarized light or elliptically polarized light) through modulation according to the image signal. The second polarizing plate 115d is a polarizing plate that cuts off p-polarized light and causes s-polarized light to pass therethrough. Accordingly, the liquid crystal light valve 115 modulates red light R according to the image signal, and emits modulated red light R toward the cross dichroic prism 119. The λ/2 phase difference plate 115a and the first polarizing plate 115b are arranged in a state in which the λ/2 phase difference plate 115a and the first polarizing plate 115b come into contact with a transparent glass plate 115e which does not convert polarized light, and it is possible to prevent distortion of the λ/2 phase difference plate 115a and the first polarizing plate 115b due to the generation of heat.

A liquid crystal light valve 116 is a transmission-type liquid crystal apparatus that modulates green light G, which is reflected in the dichroic mirror 114 after being reflected in the dichroic mirror 113, according to the image signal. The liquid crystal light valve 116 includes a first polarizing plate 116b, an electro-optical device 100 (green electro-optical device 100G), and a second polarizing plate 116d, similar to the liquid crystal light valve 115. Green light G, which is incident into the liquid crystal light valve 116, is s-polarized light which is reflected in and incident into the dichroic mirrors 113 and 114. The first polarizing plate 116b is a polarizing plate that cuts off p-polarized light and causes s-polarized light to pass therethrough. The electro-optical device 100 (green electro-optical device 100G) is formed to convert s-polarized light into p-polarized light (in a case of halftone, circularly polarized light or elliptically polarized light) through modulation according to the image signal. The second polarizing plate 116d is a polarizing plate that cuts off s-polarized light and causes p-polarized light to pass therethrough. Accordingly, the liquid crystal light valve 116 modulates green light G according to the image signal, and emits modulated green light G toward the cross dichroic prism 119.

The liquid crystal light valve 117 is a transmission-type liquid crystal apparatus that modulates blue light B, which is reflected in the dichroic mirror 113 and passes through the relay system 120 after passing through the dichroic mirror 114, according to the image signal. The liquid crystal light valve 117 includes a λ/2 phase difference plate 117a, a first polarizing plate 117b, an electro-optical device 100 (blue electro-optical device 100B), and a second polarizing plate 117d, similar to the liquid crystal light valves 115 and 116. Blue light B, which is incident into the liquid crystal light valve 117, is reflected in the two reflection mirrors 125a and 125b of the relay system 120 after being reflected in the dichroic mirror 113 and passing through the dichroic mirror 114, and thus blue light B becomes s-polarized light.

The λ/2 phase difference plate 117a is an optical element that converts s-polarized light, which is incident into the liquid crystal light valve 117, into p-polarized light. The first polarizing plate 117b is a polarizing plate that cuts off s-polarized light and causes p-polarized light to pass therethrough. The electro-optical device 100 (blue electro-optical device 100B) is formed to convert p-polarized light into s-polarized light (in a case of halftone, circularly polarized light or elliptically polarized light) through modulation according to the image signal. The second polarizing plate 117d is a polarizing plate that cuts off p-polarized light and causes s-polarized light to pass therethrough. Accordingly, the liquid crystal light valve 117 modulates blue light B according to the image signal, and emits modulated blue light B toward the cross dichroic prism 119. Meanwhile, the λ/2 phase difference plate 117a and the first polarizing plate 117b are arranged in a state in which the λ/2 phase difference plate 117a and the first polarizing plate 117b come into contact with a glass plate 117e.

The relay system 120 includes relay lenses 124a and 124b and reflection mirrors 125a and 125b. The relay lenses 124a and 124b are provided to prevent optical loss due to long optical path of blue light B. The relay lens 124a is arranged between the dichroic mirror 114 and the reflection mirror 125a. The relay lens 124b is arranged between the reflection mirrors 125a and 125b. The reflection mirror 125a reflects blue light B, which passes through the dichroic mirror 114 and is emitted from the relay lens 124a, toward the relay lens 124b. The reflection mirror 125b reflects blue light B, which is emitted from the relay lens 124b, toward the liquid crystal light valve 117.

The cross dichroic prism 119 is a color synthesis optical system in which two dichroic films 119a and 119b are perpendicularly arranged in an X-shape. The dichroic film 119a is a film which reflects blue light B and causes green light G to pass therethrough, and the dichroic film 119b is a film which reflects red light R and causes green light G to pass therethrough. Accordingly, the cross dichroic prism 119 synthesizes red light R, green light G, and blue light B which are modulated in respective liquid crystal light valves 115 to 117, and emits synthesized light toward the projection optical system 118.

Meanwhile, light which is incident into the cross dichroic prism 119 from the liquid crystal light valves 115 and 117 is s-polarized light, and light which is incident into the cross dichroic prism 119 from the liquid crystal light valve 116 is p-polarized light. As above, in a case in which light which is incident into the cross dichroic prism 119 is converted into different types of polarized light, it is possible to synthesize light which is incident from each of the liquid crystal light valves 115 to 117 in the cross dichroic prism 119. Here, generally, the dichroic films 119a and 119b are excellent in reflectance properties of s-polarized light. Therefore, it is assumed that red light R and blue light B which are reflected in the dichroic films 119a and 119b are s-polarized light and green light G which passes through the dichroic films 119a and 119b is p-polarized light. The projection optical system 118 includes projection lenses (not shown in the drawing), and projects light which is synthesized in the cross dichroic prism 119 on to a projection member 111 such as the screen.

### Other Transmission-Type Liquid Crystal Apparatuses

In the transmission-type liquid crystal apparatus, an LED light source, which emits light of the respective colors, or the like may be used as the light-source section, and respective colors which are emitted from the LED light source may be supplied to separated liquid crystal apparatuses.

The electro-optical device 100 to which the invention is applied may be used for a projection-type Head-Up Display (HUD) or a direct viewing type Head Mounted Display (HMD), a mobile phone, a Personal Digital Assistants (PDA), a digital camera, a liquid crystal television, a car navigation apparatus, a video phone and the like, in addition to the electronic apparatus.

The entire disclosure of Japanese Patent Application No. 2015-183743, filed Sep. 17, 2015 is expressly incorporated by reference herein.

What is claimed is:

1. An electro-optical device comprising:
a light-transmitting substrate that has a lens surface which include concave surface or convex surface on one surface of the light-transmitting substrate;
a light-transmitting lens layer that covers the lens surface; and
a pixel electrode that is provided over the lens layer on a side opposite to the substrate and overlaps the lens surface in plan view,
wherein the one surface of the light-transmitting lens layer has a recess region provided the lens surface and an outside region positioned at an outer side of the recess region,
wherein the lens surface is provided at a bottom of the recess region,
wherein the lens layer is provided such that an inner side of the recess region is filled, and
wherein a surface of the lens layer on the side opposite to the substrate and a surface of the outside region have a plane surface which is contiguous with each other.

2. The electro-optical device according to claim 1,
wherein at least some parts of the lens surface are connected to at least some parts of adjacent lens surfaces.

3. The electro-optical device according to claim 2,
wherein all circumferences of the lens surface is connected to any of lens surfaces which are positioned around the lens surface.

4. The electro-optical device according to claim 1,
wherein a concave-shaped curved surface is formed between a side surface and the bottom of the recess region.

5. An electro-optical device manufacturing method comprising:
forming a recess region on one surface of a light-transmitting substrate;
forming a plurality of lens surfaces that include concave surfaces or convex surfaces at a bottom of the recess region;
forming a light-transmitting lens layer on one surface of the substrate such that an inside of the recess region is filled;
flattening the lens layer from a side opposite to the substrate and causing a surface of the lens layer on the side opposite to the substrate to form, on one surface of the substrate, a plane surface which is contiguous with an outside region positioned on an outer side of the recess region; and
forming a plurality of pixel electrodes that overlap the plurality of respective lens surfaces in a plan view on the side opposite to the substrate.

6. The electro-optical device manufacturing method according to claim 5,
wherein the forming of the recess region includes performing wet etching on one surface in a state in which an etching mask is formed on one surface of the substrate.

7. An electronic apparatus comprising an electro-optical device according to claim 1.

8. An electronic apparatus comprising an electro-optical device according to claim 2.

9. An electronic apparatus comprising an electro-optical device according to claim 3.

10. An electronic apparatus comprising an electro-optical device according to claim 4.
